(19) United States
(12) Patent Application Publication
(10) Pub. No.: US 2004/0264195 A1
(43) Pub. Date: Dec. 30, 2004

(54) LED LIGHT SOURCE HAVING A HEAT SINK

(76) Inventors: Chia-Fu Chang, Hsin-Chu City (TW); Ching-Chi Shaw, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,093

(22) Filed: Jun. 25, 2003

(51) Int. Cl. F21V 29/00

(52) U.S. Cl. 362/294; 362/373; 362/240; 362/800

(57) ABSTRACT

A light emitting diode (LED) light source includes a printed circuit board, a heat sink, a plurality of heat conductors, and at least one LED chip. The printed circuit board (PCB) has a plurality of holes. The heat sink connects under the PCB for conducting heat. Each heat conductor is formed on the heat sink corresponding to each hole of the PCB for conducting heat, and each heat conductor has a basin on the topside. The LED chip is attached to the basin of the heat conductor.

### BACKGROUND OF INVENTION

1. Field of the Invention

The present invention relates to a light source, and more particularly, to an LED light source having a heat sink.

2. Description of the Prior Art

Light bulbs are essential items in modern daily life. Among all kinds of bulbs, tungsten lamps and mercury-vapor lamps are the most commonly used. However, the light emitted from the tungsten lamp is not efficient since most of the electricity applied for emitting light is transformed into heat energy. Among other effects, this can increase the workload of air conditioning systems in subtropical regions. In comparison with the tungsten lamp, the mercury-vapor lamp has a better light emitting efficiency. However, the mercury used in the lamp frequently causes environmental pollution. Thus, it is important to develop a method of fabricating a bulb having high light emitting efficiency and low risk of contamination to the environment.

Light emitting diode (LED) bulbshave therefore been invented to meet the requirements illustrated in the preceding paragraph. An LED is a semiconductor device with a long life, which is 50 to 100 times the life of a prior art bulb. An LED consumes less electrical energy, about approximately one-third to one-fifth of the electrical energy needed by a prior art bulb, during the light emitting process due to its improved light emitting efficiency. In addition, the LED bulb has a volume that is much smaller than that of a prior art bulb. Consequently, the LED bulb can replace the tungsten lamp and the mercury-vapor lamp as the most important light-emitting device in the future.

Because LEDs are point sources, they are usually used in small lighting applications such as decorative lighting. In a small lighting application, heat is an insignificant problem. When LEDs are applied in large-area illumination applications, a plurality of LEDs are grouped together with lens or a reflective mirror to focus the light so that many point sources becomes a plane source. The heat problem becomes considerable when a plurality of LEDs are illuminated together. In addition, an LED reduces the current when the working temperature is high to prevent burning out. Therefore, the heat problem becomes important in LED applications. Good heat diffusion will enhance the light emitting efficiency and prevent the LED failing. In addition, the work environment and temperature of the LED or the heat of the LED itself indirectly or directly influences the lifetime of the LED.

The light emitting efficiency and the working current of the LED are related, in general, the larger the working current of the LED, the brighter the light. The light emitting efficiency of the LED increases nonlinearly as the work current of the LED increases. For example, when the LED works under a full duty cycle at 10 mA DC, the brightness of the LED is not equal to the brightness of the LED that works under a 1/8 duty cycle at 80 mA DC. When the LED works under a 1/8 duty cycle at 50 mA DC this brightness can be approached. However, larger the working current means higher temperature. Typically, LEDs have protection from over heating starting when the temperature is larger than a limiting value. Under this protection, the working current of the LED is limited to prevent the LED from failing. From the above, if the LED has a good heat sink, this can not only enhance the light emitting efficiency but also prevent the LED from heat related failure.

### SUMMARY OF INVENTION

It is therefore a primary objective of the claimed invention to provide an LED light source having a heat sink to solve the above-mentioned problem.

According to the claimed invention, a light emitting diode (LED) light source comprises: a printed circuit board (PCB) having a plurality of holes; a heat sink connected under the PCB for conducting heat; a plurality of heat conductors formed on the heat sink corresponding to each hole of the PCB for conducting heat, each heat conductor having a basin on the topside; and at least one LED attached to the basin of the heat conductor.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

Fig.1 is a perspective view of a PCB board and a heat sink of an LED light source according to the present invention.

Fig.2 is a perspective view of the assembly of Fig.1.

Fig.3 is cross-sectional view of the LED light source according to present invention.

### DETAILED DESCRIPTION

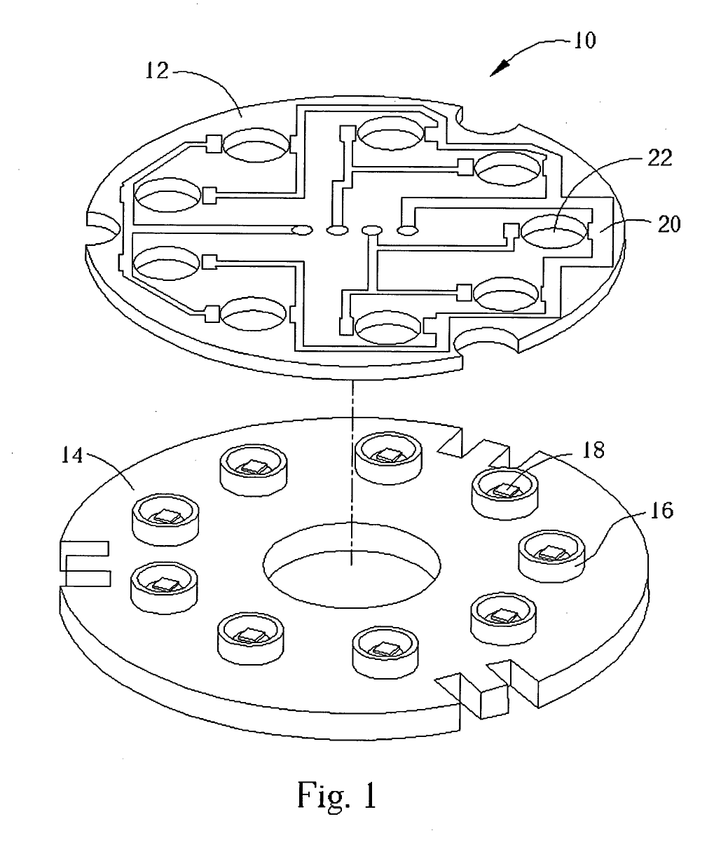

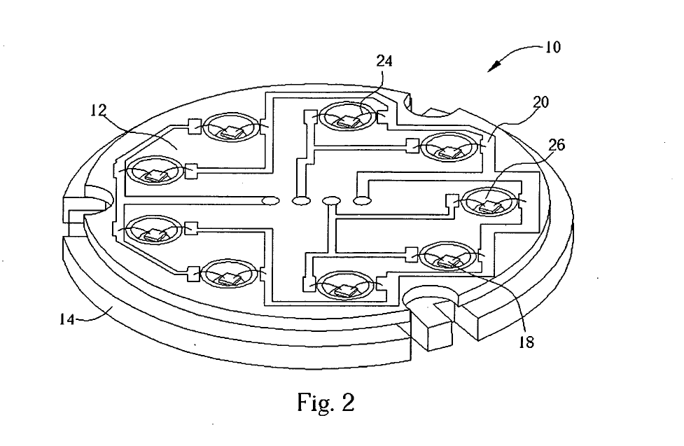

Please refer to Fig.1 and Fig. 2. Fig.1 is a perspective view of an LED light source 10 according to the present invention. Fig.2 is a view of the assembly shown in Fig.1. The LED light source 10 includes a printed circuit board (PCB) 12, a heat sink 14, a plurality of heat conductors 16, a plurality of LED chips18, a plurality of copper electrodes 20, and a plurality of conductive metal wires 24. The PCB 12 has a plurality of holes 22 for containing the heat conductors 16 formed on the heat sink 14. The location of the holes 22 corresponds to the heat conductor 16 on the heat sink 14 for combining the PCB 12 and the heat sink 14. The arrangement of the holes 22 is related to an optical design for bettering brightness. The heat sink 14 is manufactured by stamping, casting, or injection molding with aluminum. The aluminum material not only provides good heat diffusion, but also provides for ease of forming to match the PCB 12. The heat conductor 16 has a recess or basin 26 on the topside for installing the LED chips 18. The LED chips 18 installed in the basin 26 are capable of transmitting the heat quickly through heat conductor 16 to the bottom side of the heat sink 14. The number of chips 18 installed in the basin 26 depends on the capacity of the basin 26 and the size of the LED chips 18. In addition, the surface of the basin 26 is capable of performing as an optical mirror for reflecting and focusing light emitted from the LED chips 18. After combining the PCB 12 and the heat sink 14, the electrode of the LED chips 18 is connected to the copper electrode 20 of the PCB 12 by conductive metal wires 24 to complete the LED light source 10.

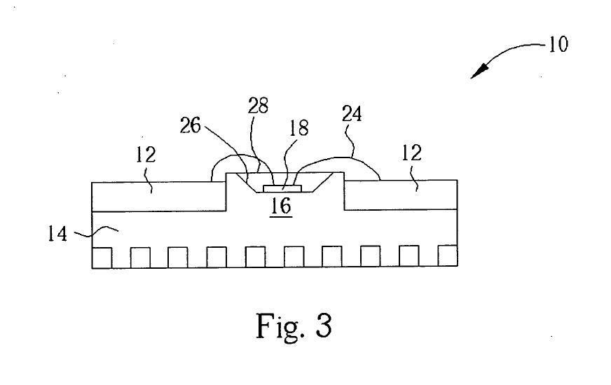

Please refer to Fig.3. Fig.3 is a cross-sectional view of the LED light source 10 according to the present invention. The heat conductors 16 and the heat sink 14 are formed as a unit. The PCB 12 having a plurality of holes 22 to contain the heat conductors 16 is installed on the heat sink 14. The topside of the heat conductor 16 is formed with a concave surface forming the basin 26. The concave surface is capable of reflecting the light from the LED chips 18. The LED light source 10 further includes a lens 28 installed on the basin 26 to focus light. In general, epoxy or silver epoxy is used to fix the LED chips 18 in the basin 26. Epoxy is an adhesive and an insulator, while silver epoxy is an adhesive and a conductor. Some LEDs such as blue light LEDs have a positive electrode and a negative electrode on the same side of the LED, however, some LEDs such as red light LEDs have a positive electrode and a negative electrode on different sides of the LED. If an LED has electrodes on the same side, epoxy or silver epoxy is used to fix the LED. If an LED has electrodes on different sides, silver epoxy is used and an insulation layer is formed between the silver epoxy and the surface of the basin for connecting LEDs in series. The LED chips 18 installed on the basin 26 can transmit heat quickly through the heat conductor 16 to the bottom side of the heat sink 14. Heat is readily transmitted to the environment through other devices such as a of the LED light assembly (not shown), when heat is transmitted from the heat sink 14.

In contrast to the prior art, the LED light source 10 according to the present invention provides an assembly having the PCB 12 to connect the LED chips 18 and the heat sink 14 to transmit heat. The heat conductor 16 formed from the heat sink 14 provides good heat diffusion so that a plurality of LED chips 18 can be installed together. The PCB 12 provides connection to a plurality of LED chips 18 installed together so that the brightness of the light source is increased. In addition, the PCB 12 and the heat sink 14 are formed of aluminum using mature manufacturing techniques reducing cost.

Those skilled in the art will readily observe that numerous modifications and alterations of the device may be made while retaining the teachings of the invention. Accordingly, the above disclosure should be construed as limited only by the metes and bounds of the appended claims.

1. a light emitting diode (led) light source comprising:
a printed circuit board (PCB) having a plurality of holes;
a heat sink connected under the PCB for conducting heat;
a plurality of heat conductors protruding the heat sink and formed on the heat sink corresponding to each hole of the PCB for conducting heat, each heat conductor having a basin on the topside; and at least one LED chip attached to the basin of the heat conductor.

2. The light source of claim 1 further comprising a plurality of conductive metal wires connected between an electrode of the LED chip and an electrode of the PCB.

3. The light source of claim 1 wherein the material of the heat sink is aluminum.

4. The light source of claim 3 wherein the material of the heat conductor is aluminum formed from the aluminum heat sink.

5. The light source of claim 1 further comprising an adhesive for fixing the LED chip.

6. The light source of claim 5 wherein the adhesive is epoxy or silver epoxy.

7. The light source of claim 1 further comprising a housing for reflecting light and helping transmit heat.

8. The light source of claim 1 further comprising a lens for focusing the light from the LED chip.
